(19) United States
(12) Patent Application Publication
(10) Pub. No.: US 2019/0287503 A1
(43) Pub. Date: Sep. 19, 2019

(54) ELECTRIC BASS MARIMBULA DEVICE

(71) Applicant: Carlos Inocente Perez Bomboust, Jacksonville, FL (US)

(72) Inventor: Carlos Inocente Perez Bomboust, Jacksonville, FL (US)

(21) Appl. No.: 16/299,830

(22) Filed: Mar. 12, 2019

Related U.S. Application Data
(60) Provisional application No. 62/644,028, filed on Mar. 16, 2018.

(51) Int. Cl. G10H 1/34; G10H 1/00; G10H 3/14

(52) U.S. Cl. CPC G10H 1/344; G10H 2220/461; G10H 3/14; G10H 1/0008

(57) ABSTRACT

An electric bass marimbula device may include a bridge assembly having a cover and a base. The cover may have a cover face and the base may have a base face. One or more key plates may be coupled between the cover face and the base face. One or more pickups may be coupled between the cover face and the base face, and each pickup may be in contact with a key plate. Optionally, the device may include one or more counter bores which may be positioned in the cover or the base, and a portion of a pickup may be positioned in a counter bore. Optionally, the device may include one or more fasteners which may be configured to couple the base and cover together. Preferably, a counter bore may be positioned between two fasteners.

### CROSS REFERENCE TO RELATED APPLICATIONS

This application claims priority to and the benefit of the filing date of U.S. Provisional Application No. 62/644,028, filed on Mar. 16, 2018, entitled “ELECTRIC BASS MARIMBULA”, which is hereby incorporated by reference in its entirety.

### FIELD OF THE INVENTION

This patent specification relates to the field of musical instruments. More specifically, this patent specification relates to an electric Bass Marimbula.

### BACKGROUND

The Traditional Acoustical Bass Marimbula consists of: a rectangular wooden box or cajón, a wooden bridge, and metal key plates. The Traditional Bass Marimbula is constructed of wood—(other materials, including steel, have been used to accomplished similar acoustical results as the wooden box construction). The box or cajon is rectangular, measuring approximately: 23″ in length, 8″ in width and 17″ in height; typical in Guantanamo, Cuba. For the most part, the wooden material used in the construction of the Acoustical Bass Marimbula box is cedar or another lightweight local wooden material. The Marimbula box walls are fabricated of thin cedar boards that measure ¼″ or less in thickness. A ¼″ round molding is glued along the inside corners of the box where all 4 sides meet.

The top and bottom of the box are fabricated of thicker boards of cedar. The bridge consists of: The base, the cover and the metal key plates. Typically, the bridge's base is a rectangular piece of machined solid hardwood approximately ¾″ thick, 1½″ wide and 20″ long. The hardwood could be oak, poplar, granadillo or any other local hardwood species. The base of the bridge is attached to the front face of the Marimbula and secured with screws. The length of the bridge is constraint by the length of the Marimbula box. In some cases, the Marimbuleros (Marimbula player) have used steel member for the bridge base. The bridge cover in most cases is identical to the bridge base and of the same material. Nevertheless, some people use different wooden material and different thickness. The metal key plates being traditionally fabricated of strip flat harden and temper spring steel. In Cuba, today, any heat-treated laminated flat steel is good to make metal key plates as long as you get the desired pitch. The ideal material is the old industrial metal strap material or old saw material because of their quality in achieving and holding a pitch.

In the traditional Marimbula, the bridge assembly contains anywhere from 4 to 9 metal key plates. 7 or 8 metal key plates has been the most popular and of late, 9 metal key plates bridge assembly is preferred.

The Marimbula is played by plucking the metal key plates with your finger's distal phalanx. This action required sliding the finger distal phalanx along the length or some part of the metal key plates and at the same time adding some pressure to the key plate until the finger leaves the plate. This creates a vibratory response of the metal key plate and therefore a sound wave. Classically, the middle and the index fingers distal phalanx of either hand are used to create this vibratory response from the metal key plates. Tuning is accomplished by losing the screws at either side of the metal key plate in the stations and sliding the metal key plates up or down until the desired pitch is achieved. In the bridge assembly, the longest metal key plate creates the lower pitched sound; considering all the metal key plates are the same width and thickness and have the same material properties. The vibration created by plucking the metal key plates travel throughout the bridge assembly as sound waves. The sound waves resonate into the box or cajón where it gets amplified and emitted to the ambient space surrounding the box as audible sound waves. In the front or face of the Marimbula box, holes have been added close to the bridge assembly to increase the free dispersion of the sound waves to the outside of the box.

The Marimbula is light in weight for its size but cumbersome to carry because of its geometry. The sound reproduction of the Marimbula is hardly audible for the keys at the end of the bridge near the edge of the box. When a musical ensemble is playing, a traditional Marimbula must be amplified with a microphone or two for it to be audible.

Many people have tried to make the Traditional Acoustic Bass Marimbula more portable by changing the geometrical configuration of the box but have encountered issues with sound reproduction, amplification and other negative factors affecting the reproduction of sound.

In other cases, some have tried to make an electronic Marimbula to no avail. In the quest to electrify the Marimbula, some have used multiple microphones or transducers inside and outside the Marimbula box without obtaining the desired amplified sound response effect. Therefore, a need exists for a novel Marimbula that does not suffer from these drawbacks.

### BRIEF SUMMARY OF THE INVENTION

An electric bass marimbula device is provided. In some embodiments, the device may include a bridge assembly having a cover and a base. The cover may have a cover face and the base may have a base face. One or more key plates may be coupled between the cover face and the base face. One or more pickups may be coupled between the cover face and the base face, and each pickup may be in contact with a key plate.

In further embodiments, the device may include one or more counter bores, which may be positioned in the cover or the base. A portion of a pickup may be positioned in a counter bore.

In further embodiments, the device may include one or more fasteners which may be configured to couple the base and cover together. Preferably, a counter bore may be positioned between two fasteners.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a first side elevation view of an example of an electric bass marimbula device according to various embodiments described herein.

FIG. 2 illustrates a second side elevation view of an example of an electric bass marimbula device according to various embodiments described herein.

FIG. 3 shows a front side elevation view of an example of an electric bass marimbula device according to various embodiments described herein.

FIG. 4 depicts a rear side elevation view of an example of an electric bass marimbula device according to various embodiments described herein.

FIG. 5 illustrates a sectional, through line 5-5 shown in FIG. 3, elevation view of an example of an electric bass marimbula device according to various embodiments described herein.

FIG. 6 shows a side elevation view of an example of a cover having counter bores according to various embodiments described herein.

FIG. 7 depicts a side elevation view of an example of a base having counter bores according to various embodiments described herein.

FIG. 8 illustrates a perspective exploded view of an electric bass marimbula device according to various embodiments described herein.

FIG. 9 shows a block diagram of an example of an electric bass marimbula device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

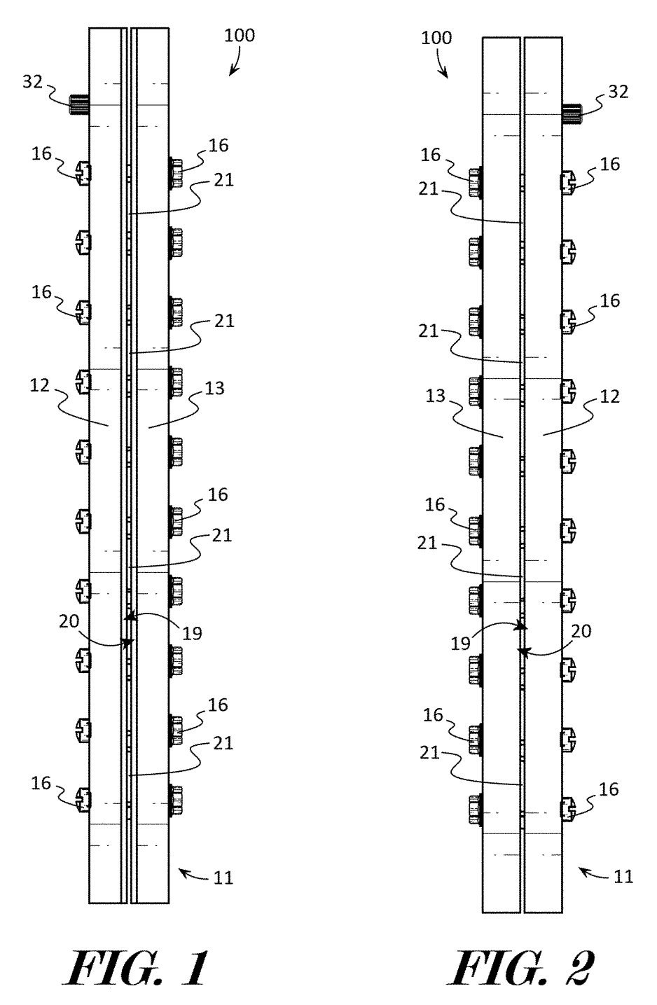

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new Marimbula instrument is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

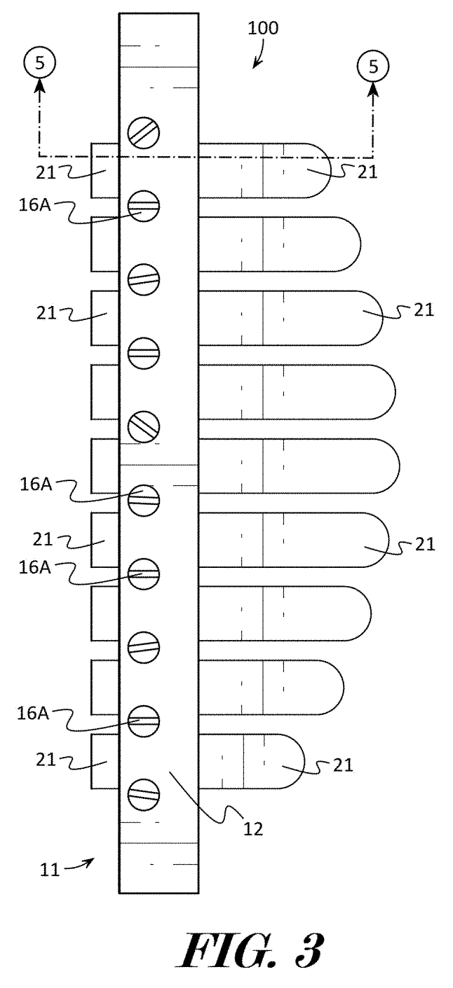

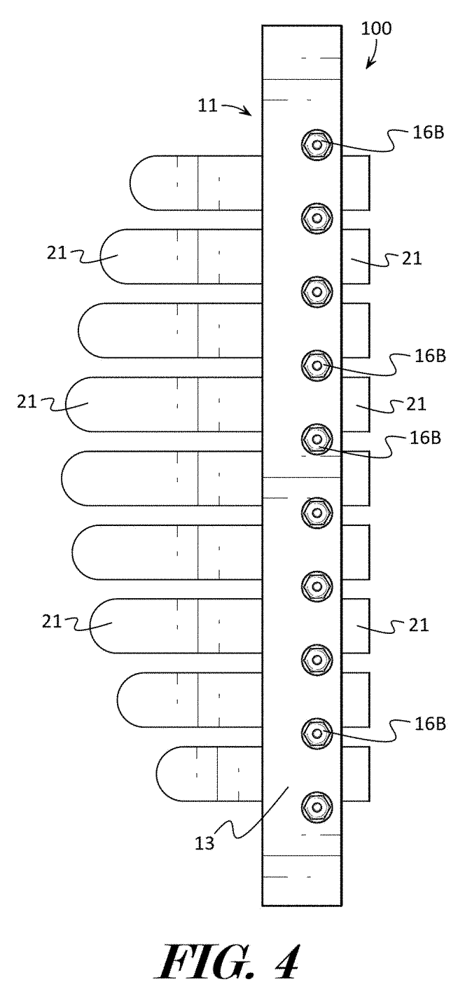

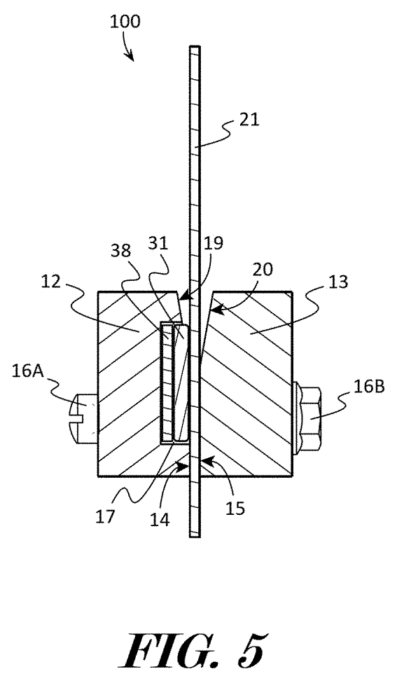

The present invention will now be described by example and through referencing the appended figures representing preferred and alternative embodiments. FIGS. 1-4 illustrate an example of an electric bass marimbula device (“the device”) 100 according to various embodiments. In some embodiments, the device may comprise a bridge assembly 11 having a cover 12 and a base 13. The cover 12 may have a cover face 14 and the base 13 may have a base face 15. One or more key plates 21 may be coupled between the cover face 14 and the base face 15. One or more pickups 31 may be coupled between the cover face 14 and the base face 15, and each pickup 31 may be in contact with a key plate 21.

In some embodiments, the device 100 may comprise a bridge assembly 11 which may be configured as a structure for positioning and coupling the key plates 21 and pickups 31 together. In preferred embodiments, the bridge assembly 11 may comprise a cover 12 and a base 13 between which the key plates 21 and pickups 31 may be positioned, such as by being sandwiched between. A cover 12 may comprise one or more cover faces 14, and a base 13 may comprise one or more base faces 15. A cover face 14 may form a surface of the cover 12 which may contact one portion of at least one key plate 21, while a base face 15 may form a surface of the base 13 which may contact an opposing portion of at least one key plate 21 so that the key plate(s) 21 may be gripped or frictionally coupled between the cover face(s) 14 and base face(s) 15.

A bridge assembly 11, and therefore a cover 12 and a base 13, may be configured in any size and shape. In preferred embodiments, a bridge assembly 11, and therefore a cover 12 and a base 13, may comprise a generally elongated shape. In further embodiments, a cover 12 and/or a base 13 may comprise a generally elongated prism shape. Likewise, a cover face 14 and a base face 15 may be configured in any size and shape which may enable them to contact opposing sides of key plate(s) 21. For example, a cover face 14 and/or a base face 15 may be configured with a flat or planar shape, a convex or concave shape, or any other shape and/or texturing.

A bridge assembly 11, and therefore a cover 12 and a base 13, may be made from or may comprise any material. In preferred embodiments, a bridge assembly 11, and therefore a cover 12 and/or a base 13, may be made from or may comprise a wood or plant-based material such as oak, poplar, granadillo, other hard woods, soft woods, bamboo, or the like. In some embodiments, a bridge assembly 11, and therefore a cover 12 and/or a base 13, may be made from or may comprise steel alloys, aluminum, aluminum alloys, copper alloys, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, bamboo, other plant based materials, or any other material including combinations of materials that are substantially rigid. In further embodiments, a bridge assembly 11, and therefore a cover 12 and/or a base 13, may comprise cushioning materials, such as silicone foams, rubber foams, urethane foams including plastic foams, neoprene foam, latex foam rubber, polyurethane foam rubber, or elastomer materials such as elastic plastics, elastic silicone, elastic rubbers; and/or any other material including combinations of materials.

The device 100 may comprise one or more, and more preferably between nine and thirty, key plates 21 which may be coupled to the bridge assembly 11. The key plates 21 may be configured in any shape and size. In some embodiments, a key plate 21 may be made from or may comprise heat-treated laminated flat steel, while in other embodiments, a key plate 21 may be made from or may comprise any other metal or metal alloy and/or any other material. In preferred embodiments, two or more, and preferably all, key plates 21 may be coupled between a cover 12 and a base 13 so that the key plates 21 may be generally in the same plane. While the key plates 21 may be preferably linearly aligned as perhaps best shown in FIGS. 1-4, it should be understood that the key plates 21 may be radially oriented, disposed in two or more planes, or configured with any other orientation.

In some embodiments, the device 100 may comprise one or more fasteners 16 which may be configured to tension the cover 12 and base 13 together thereby securing or coupling, such as by frictionally coupling, the key plates 21 to the bridge assembly 11 between a cover face 14 and a base face 15. Optionally, a fastener 16 may be received in or coupled to a fastener aperture 36, and the device 100 may comprise one or more fastener apertures 36 which may be disposed in a cover 12 and/or base 13. In preferred embodiments, the fasteners 16 may adjustably tension the cover 12 and base 13 together so that the tension may be increased and decreased. In further preferred embodiments, portions of a key plate 21 may be positioned between two fasteners 16 and the fasteners 16 may adjustably tension the cover 12 and base 13 together so that by increasing and decreasing the tension, the resonance of the key plate 21 may be increased and decreased, respectively. Preferably, each key plate 21 may be positioned between two fasteners 16. For example, a device 100 may comprise ten fasteners 16 and nine key plates 21 with each key plate 21 positioned between two adjacent fasteners 16.

In some embodiments, a fastener 16 may comprise a male fastener 16A and/or a female fastener 16B which may be coupled together, such as by being removably coupled together. In preferred embodiments, a male fastener 16A may comprise a screw, bolt, or other male threaded fastener, and a female fastener 16B may comprise a nut, wingnut, or other female threaded fastener. In other embodiments, a fastener 16 may be configured as a clasp type fastener, clip type fastener, rivet type fastener, or any other suitable joining method which may be used to couple the key plates 21 to the bridge assembly 11.

The device 100 may comprise one or more pickups 31 and preferably the number of pickups 31 and key plates 21 may be equal or in any other ratio. In preferred embodiments, each pickup 31 may be positioned proximate to, such as in contact with, a key plate 21 as shown in FIG. 5. Generally, a pickup 31 may comprise a transducer that captures or senses mechanical vibrations produced by musical instruments and converts these to an electrical signal that may optionally be amplified using an instrument amplifier to produce musical sounds, such as through a loudspeaker in a speaker enclosure, and/or optionally the signal from a pickup 31 may be recorded directly. In some embodiments, the device 100 may comprise one or more pickups 31 which may be configured as magnetic pickups, and which may be used to convert magnetic field vibrations resulting from a user plucking or otherwise manipulating a key plate 21 into an electrical signal. In preferred embodiments, the device 100 may comprise one or more pickups 31 which may be configured as piezoelectric pickups, and which may be used to convert physical vibrations resulting from a user plucking or otherwise manipulating a key plate 21 into an electrical signal. The pickups 31 may be in electrical communication with an output plug 32 which may be configured to receive and electrically communicate with a male plug member, such as a 3.5 mm stereo phone connector, male USB connector, or any other electrical connector commonly used to connect to electrical instruments.

In some embodiments, the device 100 may comprise one or more counter bores 17. Generally, a counter bore 17 may comprise an aperture or depression in a cover 12 or base 13 into which portions of a pickup 31 may be positioned. A counter bore 17 may be positioned in a cover 12 or base 13 so that a pickup 31 positioned in the counter bore 17 may be positioned proximate to, such as in contact with, a key plate 21. In further embodiments, similar to a key plate 21, a counter bore 17 may be positioned in a cover 12 or base 13 so that the counter bore 17 may be positioned between two adjacent fasteners 16. Preferably, a counter bore 17 may be configured with a shape that is substantially complementary to the shape of portions of the pickup 31 that may be positioned in the counter bore 17 so that the pickup 31 may be maintained in contact with the keyplate 21 when the keyplate 21 is coupled between the cover 12 and base 13.

In some embodiments, a tensioner 38 (FIG. 5) may be positioned in a counter bore 17 and the tensioner 38 may tension portions of a pickup 31 positioned in the counter bore 17 into contact with a keyplate 21. For example, a tensioner 38 may comprise a piece of felt or other fabric, silicone, rubber, or other resilient polymer, a spring, or any other element which may resist deformation to tension or compress a pickup 31 positioned in the counter bore 17 into contact with a keyplate 21.

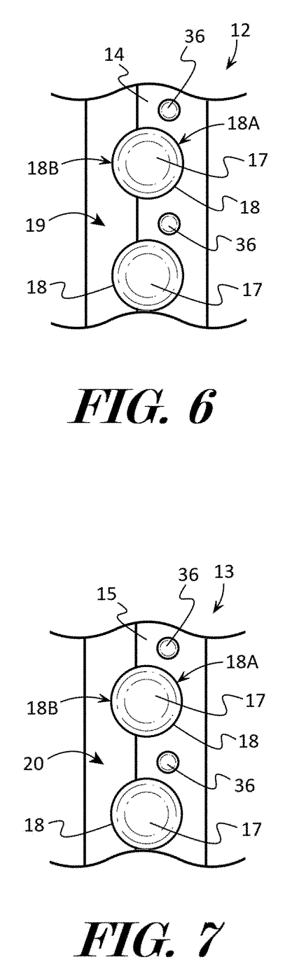

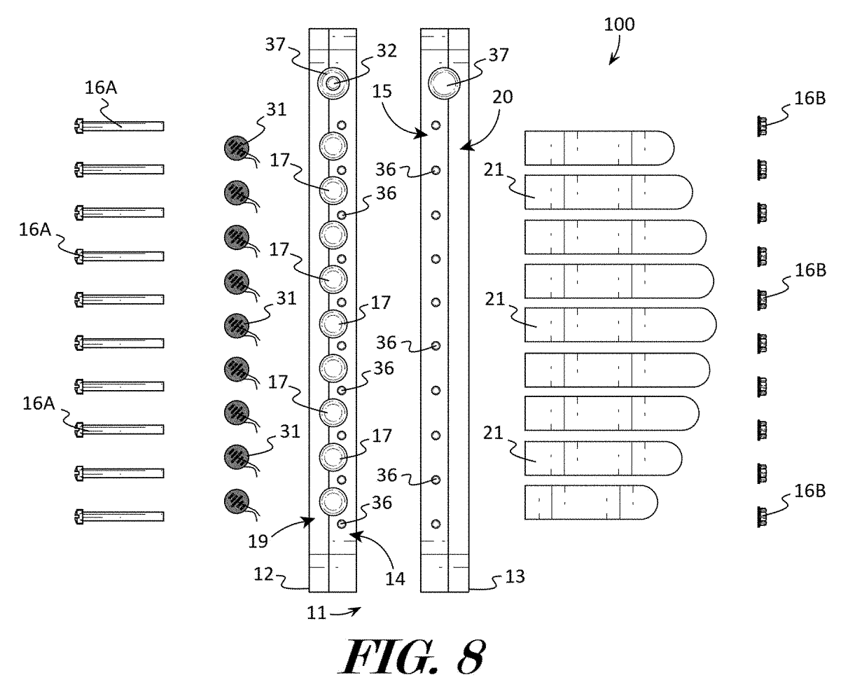

As perhaps best shown in FIGS. 6 and 7, a counter bore 17 may comprise a depression or aperture having a perimeter 18 which may form the uppermost boundary of the counter bore 17. In some embodiments, a counter bore 17 may be disposed in a cover 12 and a cover face 14 may be coupled to a portion of the perimeter 18. In further embodiments, the entire perimeter 18 may be coupled to a cover face 14. In preferred embodiments, a portion, such as less than 99 percent and more preferably less than 90 percent, of the perimeter 18 may be coupled to a cover face 14. In still further embodiments, a counter bore 17 may be disposed in a base 13 and a base face 15 may be coupled to a portion of the perimeter 18. In yet further embodiments, the entire perimeter 18 may be coupled to a base face 15. In preferred embodiments, a portion, such as less than 99 percent and more preferably less than 90 percent, of the perimeter 18 may be coupled to a base face 15.

In some embodiments, the device 100 may comprise one or more bevels, such as a cover bevel 19 and/or a base bevel 20. A cover bevel 19 may be formed into a cover 12 and coupled to a cover face 14, and the cover bevel 19 may be angled away or otherwise oriented away from the cover face 14 so that the cover bevel 19 may decrease the amount of the cover face 14 that may contact one or more key plates 21. In this manner a cover bevel 19 may decrease the amount of cover 12 in contact with a key plate 21 so as to decrease the amount of vibrational attenuation exerted on the key plate 21 by the cover 12. A cover bevel 19 may be configured in any size or shape. For example, a cover bevel 19 may decrease the amount of a cover face 14 that may contact one or two key plates 21. As another example, a cover bevel 19 may extend the length of the cover 12 to decrease the amount of a cover face 14 that may contact each key plate 21 of the device 100.

Similarly, a base bevel 20 may be formed into a base 13 and coupled to a base face 15, and the base bevel 20 may be angled away or otherwise oriented away from the base face 15 so that the base bevel 20 may decrease the amount of the base face 15 that may contact one or more key plates 21. In this manner a base bevel 20 may decrease the amount of base 13 in contact with a key plate 21 so as to decrease the amount of vibrational attenuation exerted on the key plate 21 by the base 13. A base bevel 20 may be configured in any size or shape. For example, a base bevel 20 may decrease the amount of a base face 15 that may contact one or two key plates 21. As another example, a base bevel 20 may extend the length of the cover 12 to decrease the amount of a base face 15 that may contact each key plate 21 of the device 100. Preferably, a cover bevel 19 and a base bevel 20 may be angled or otherwise oriented away from each other as best shown in FIG. 5.

In preferred embodiments, a counter bore 17 may comprise a perimeter 18 having a face perimeter 18A and/or a bevel perimeter 18B. Generally, a face perimeter 18A may comprise a portion of the perimeter 18 which may be coupled to or in contact with a cover face 14 or base face 15 depending on if the counter bore 17 is formed into a cover 12 or base 13, respectively, while a bevel perimeter 18B may comprise a portion of the perimeter 18 which may be coupled to or in contact with a cover bevel 19 or base bevel 20 depending on if the counter bore 17 is formed into a cover 12 or base 13 having a cover bevel 19 or base bevel 20, respectively.

In some embodiments, a counter bore 17 may be disposed in a cover 12, and both a cover face 14 and a cover bevel 19 may be coupled to a portion of the perimeter 18, such as to the face perimeter 18A and bevel perimeter 18B, respectively. In preferred embodiments, a portion, such as less than 99 percent and more preferably less than 90 percent, of the perimeter 18 may be coupled to the cover face 14 (as face perimeter 18A) while the remainder of the perimeter 18 may be coupled to a cover bevel(s) 19 (as bevel perimeter 18B). In still further embodiments, a counter bore 17 may be disposed in a base 13, and both a base face 15 and a base bevel 20 may be coupled to a portion of the perimeter 18, such as to the face perimeter 18A and bevel perimeter 18B, respectively. In preferred embodiments, a portion, such as less than 99 percent and more preferably less than 90 percent, of the perimeter 18 may be coupled to the base face 15 (as face perimeter 18A) while the remainder of the perimeter 18 may be coupled to a base bevel(s) 20 (as bevel perimeter 18B).

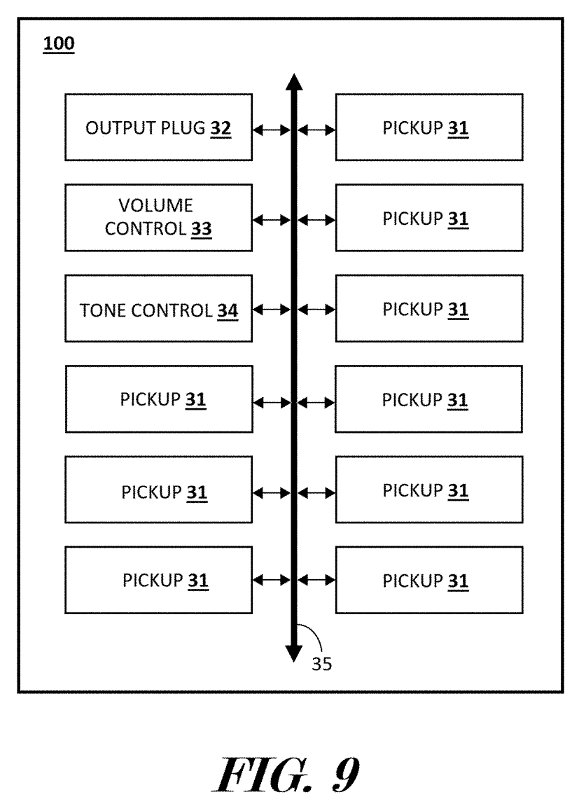

As perhaps best shown in FIG. 9, a device 100 may comprise one or more output plugs 32, volume controls 33, and/or tone controls 34 which may be in electrical communication with the one or more pickups 31 via one or more local interfaces 35. A local interface 35 can be, for example but not limited to, one or more buses, circuit boards, wiring, wire harnesses, or other wired or wireless connections, as is known in the art. The local interface 35 can have additional elements, which are omitted for simplicity, such as controllers, buffers (caches), drivers, repeaters, and receivers, among many others, to enable communications. Further, the local interface 35 may include address, control, and/or data connections to enable appropriate communications among the aforementioned components.

In some embodiments, the device 100 may comprise one or more output plugs 32. An output plug 32 may enable an electrical signal from the pickups 31 to be communicated to other electrical devices, such as amplifiers, speakers, sound boards, mixers, recording devices, computers, and the like. In preferred embodiments, an output plug 32 may comprise a 3.5 mm stereo phone connector. In other embodiments, an output plug 32 may comprise a 2.5 mm phone connector, a 6.35 mm phone connector, a USB type connector such as a USB Type-C connector, a Lightning plug connector, or any other type of connector suitable for communicating an audio output signal to another device. An output plug 32 may optionally be coupled to the bridge assembly 11, such as in an output aperture 37 which may be formed into a cover 12 and/or base 13.

In some embodiments, the device 100 may comprise a volume control 33. A volume control 33 may be configured to modulate the volume of an electrical signal generated by the pickups 31. In further embodiments, the device 100 may comprise a tone control 34. A tone control 34 may be configured to modulate the tone of an electrical signal generated by the pickups 31. A volume control 33 and/or a tone control 34 may comprise a control element that a user may interact with, such as turnable control knobs, depressible button type switches, a key pad, slide type switches, rocker type switches, touch screen graphical user interfaces (GUI), or any other suitable input that may be used to modulate electricity between components or to otherwise control functions of the device 100.

While some exemplary shapes and sizes have been provided for elements of the device 100, it should be understood to one of ordinary skill in the art that the bridge assembly 11, cover 12, base 13, key plates 21, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An electric bass marimbula device, the device comprising:
a bridge assembly having a cover and a base, the cover having a cover face and the base having a base face;
a key plate coupled between the cover face and the base face; and
a pickup coupled between the cover face and the base face, the pickup in contact with the key plate.

2. The device of claim 1, further comprising an output plug in communication with the pickup.

3. The device of claim 1, further comprising a volume control.

4. The device of claim 1, further comprising a tone control.

5. The device of claim 1, wherein the device comprises two fasteners, and wherein the counter bore is positioned between the fasteners.

6. The device of claim 6, wherein the fasteners adjustably tension the cover and base together.

7. The device of claim 1, wherein a portion of the pickup is positioned in a counter bore.

8. The device of claim 7, wherein the counter bore comprises a perimeter, and wherein a face selected from the cover face and the base face is coupled to a portion of the perimeter.

9. The device of claim 8, wherein the portion of the perimeter is less than 90 percent of the perimeter.

10. The device of claim 9, further comprising a cover bevel and a base bevel, wherein the cover bevel is angled away from the cover face, wherein the face bevel is angled away from the bevel face, and wherein the cover bevel and base bevel are angled away from each other.

11. The device of claim 10, wherein a bevel selected from the group consisting of the cover bevel and the base bevel is coupled to a portion of the perimeter.

12. An electric bass marimbula device, the device comprising:
a bridge assembly having a cover and a base, the cover having a cover face and the base having a base face;
a key plate coupled between the cover face and the base face;
a pickup coupled between the cover face and the base face, the pickup in contact with a key plate;
a counter bore, wherein a portion of the pickup is positioned in a counter bore; and
two fasteners, wherein the counter bore is positioned between the two fasteners.

13. The device of claim 12, further comprising an output plug in communication with the pickup.

14. The device of claim 12, further comprising a volume control.

15. The device of claim 12, further comprising a tone control.

16. The device of claim 12, wherein the fasteners adjustably tension the cover and base together.

17. The device of claim 12, wherein the counter bore comprises a perimeter, and wherein a face selected from the cover face and the base face is coupled to a portion of the perimeter.

18. The device of claim 17, wherein the portion of the perimeter is less than 90 percent of the perimeter.

19. The device of claim 18, further comprising a cover bevel and a base bevel, wherein the cover bevel is angled away from the cover face, wherein the base bevel is angled away from the bevel face, and wherein the cover bevel and base bevel are angled away from each other.

20. The device of claim 19, wherein a bevel selected from the group consisting of the cover bevel and base bevel contacts a portion of the perimeter.
